(19) United States
(12) Patent Application Publication
(10) Pub. No.: US 2014/0257765 A1
(43) Pub. Date: Sep. 11, 2014

(54) Numerical Simulation of FSI Using The Space-Time CE/SE Solver With A Moving Mesh For The Fluid Domain

(71) Applicant: LIVERMORE SOFTWARE TECHNOLOGY CORPORATION, (US)

(72) Inventors: Zeng-Chan Zhang, Livermore, CA (US); Grant Cook, Lathrop, CA (US)

(73) Assignee: LIVERMORE SOFTWARE TECHNOLOGY CORPORATION, Livermore, CA (US)

(21) Appl. No.: 13/786,366

(22) Filed: Mar. 5, 2013

(51) Int. Cl. G06F 17/50

(52) U.S. Cl. CPC G06F 17/5009
USPC 703/2

(57) ABSTRACT

Systems and methods of numerical simulation of FSI using the space-time CE/SE method with a moving space-time fluid mesh coupled to a method of numerically simulating structural mechanics are disclosed. A FSI interface is determined based on fluid domain and structure definitions received in a computer system. Fluid forces acting on the FSI interface are initialized. Simulated structural behaviors are obtained using FEA in response to the received fluid forces at the FSI interface. Structural behaviors include nodal positions on the structure's exterior boundary, which are used for updating the FSI interface of the space-time fluid mesh Inner nodes of the fluid mesh are adjusted accordingly using a user-selected mesh adjustment strategy. Simulated fluid behaviors are obtained by updating fluid solutions using the CE/SE solver with the adjusted fluid mesh. The fluid forces are again applied to the FEA model for obtaining simulated structural behaviors for the next solution cycle.

### FIELD

The present invention generally relates to computer-aided engineering (CAE) analysis, more particularly to numerical simulation of FSI (Fluid Structure Interaction) using the space-time conservation element and solution element(CE/SE) method with a moving space-time fluid mesh coupled to a method of numerically simulating structural mechanics (i.e., structural behaviors).

### BACKGROUND

Computer aided engineering analysis is configured to obtain numerical simulated responses/results of interest, for example, structural behaviors, fluid motions, etc. And simulated responses/results are used by engineers and/or scientists to make design decision for improving products (e.g., automobile, airplane, etc.) or to investigate certain physical phenomena that would otherwise be hard or impossible to visualize.

With the advent of computing technologies, instead of obtaining either structural behaviors or fluid motions in separate numerical simulations, a combined system of fluid and structure modeling has been used in numerical simulation of fluid structure interactions (FSI), for example, airplane in flight, ship in ocean, etc.

Prior art approaches for numerically simulating FSI have been conducted with method where space and time are treated separately. However, for high speed fluids, inaccuracies in fluid simulation become a problem. A different approach referred to as the space-time CE/SE (conservative element/solution element) method is used for fluid simulation. But, prior art approaches in the space-time CE/SE method have relied on Eulerian or fixed grid/mesh (i.e., mesh stays constant for the entire numerical simulation) to represent fluid (i.e., air) in a space-time domain with a structure (i.e., aircraft) represented by another grid model (e.g., finite element analysis model) moving through the Eulerian grid. However, as a result of the FSI interface in the fixed Eulerian grid, some accuracy is lost.

It would therefore be desirable to have improved techniques for numerically simulating FSI using the space-time CE/SE method with a moving space-time fluid mesh coupled to a method of numerically simulating structural mechanics.

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems and methods of numerically simulating fluid structure interaction (FSI) using the space-time CE/SE method with a moving fluid mesh coupled to a method of numerically simulating structural mechanics are disclosed. According to one exemplary embodiment of the present invention, a fluid domain definition and a structure definition (e.g., an airplane, a car, etc.) are received in a computer system. The fluid domain is represented by a space-time fluid mesh while the structure is represented by a finite element analysis (FEA) model. The fluid domain definition further includes fluid variables (e.g., density, velocity, pressure, viscosity, etc.). A FSI interface is determined from the received definitions. State variables of the solvers are initialized next. Then, fluid forces acting on the FSI interface are initialized at the onset of the time-marching numerical simulation of FSI.

Numerically simulated structural behaviors of the structure are obtained with FEA using the FEA model in response to the received fluid forces at the FSI interface. The structural behaviors include, but are not limited to, nodal positions on the exterior boundary of the structure, which are used for updating the FSI interface boundary of the space-time CE/SE fluid mesh. Inner nodes of the fluid mesh are adjusted accordingly using a user-selected mesh adjustment strategy, employing motions at the FSI interface as a boundary condition. Numerically simulated fluid behaviors (e.g., fluid forces at the FSI interface) are obtained by updating fluid solutions using the CE/SE solver with the adjusted space-time fluid mesh. The fluid forces are again applied to the FEA model for obtaining simulated structural behaviors for the next solution cycle at an advanced solution time. Numerical simulation of FSI continues until a predefined ending condition is reached.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1C are diagrams showing various exemplary fluid domain and structure definitions;

FIG. 1D is a diagram showing an exemplary FEA model of a structure;

FIGS. 2A-2E are schematic diagrams showing an exemplary setup of the space-time CE/SE solver for one spatial dimension in accordance with one embodiment of the present invention;

FIGS. 3A-3B are schematic diagrams showing an exemplary setup of the space-time CE/SE solver for two spatial dimensions in accordance with one embodiment of the present invention;

FIG. 4 is a diagram showing a comparison between a fixed Eulerian mesh and an exemplary moving fluid mesh that can be used in the space-time CE/SE method, according to an embodiment of the present invention;

FIG. 5A and FIG. 5B collectively show a flowchart illustrating an exemplary process of numerically simulating fluid structure interaction using the space-time CE/SE solver with moving fluid mesh, according to an embodiment of the present invention;

FIGS. 6A-6C are a series of schematic diagrams illustrating an exemplary sequence of space-time fluid mesh adjustments in accordance with one embodiment of the present invention; and

FIG. 7 is a block diagram showing salient components of an exemplary computer, in which one embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

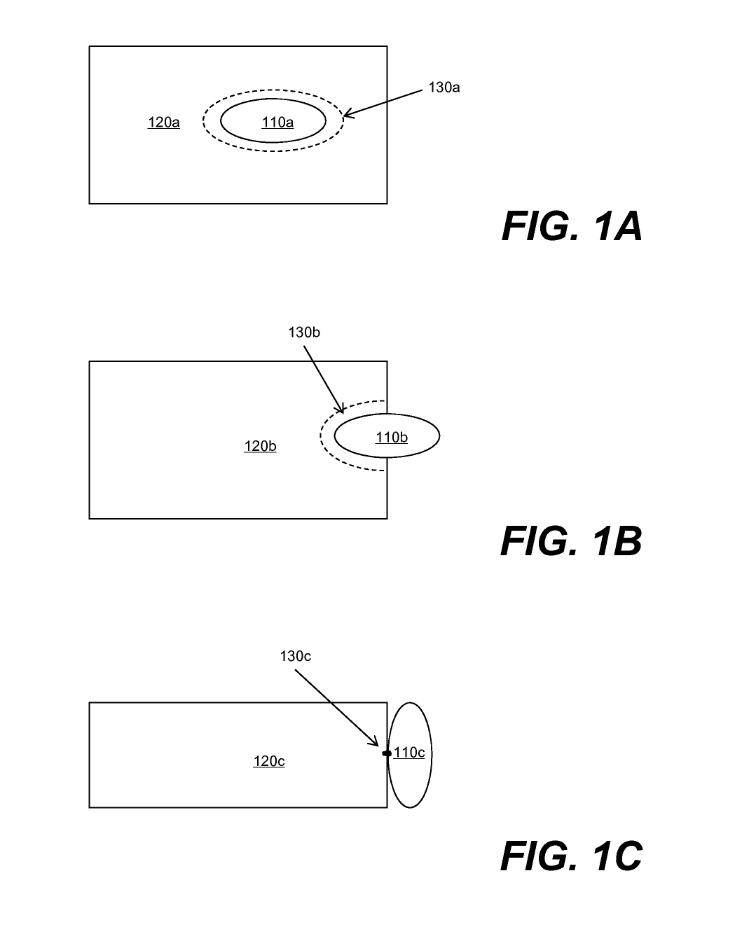

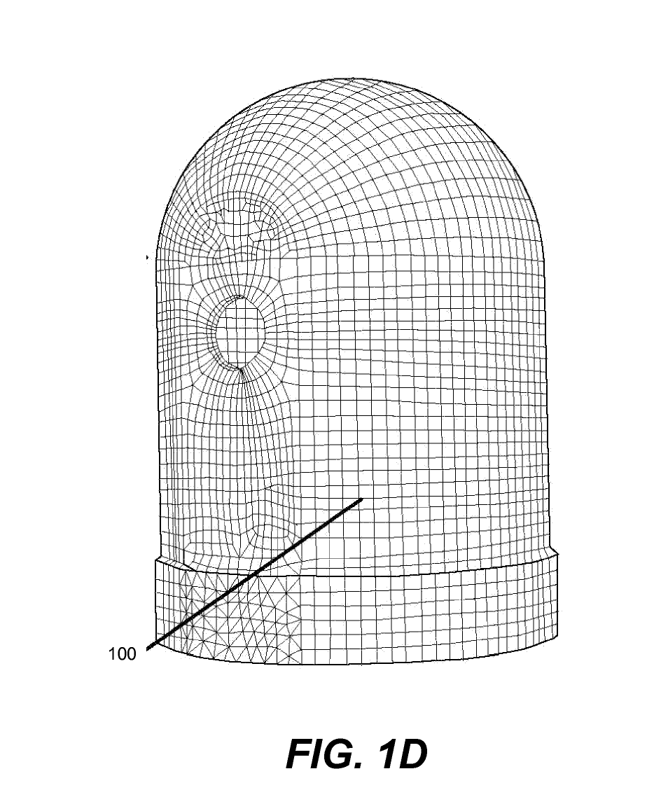

Embodiments of the present invention are discussed herein with reference to FIGS. 1A-7. However, those skilled in the art will readily appreciate that the detailed description given herein with respect to these figures is for explanatory purposes as the invention extends beyond these limited embodiments.

Systems and methods of numerically simulating fluid structure interaction (FSI) using the space-time CE/SE method with a moving fluid mesh coupled to a method of numerically simulating structural mechanics are disclosed. A time-marching simulation of FSI between a structure and a fluid domain specified by a user is conducted. FIGS. 1A-1C are diagrams showing various exemplary fluid domains 120a-120c and respective structures 110a-110c. The structure 110a can be entirely located within the fluid domain 120a, the structure 110b can also be partially located within the fluid domain 120b, or the structure 110c may be located right next to the fluid domain 120c.

Shown in FIG. 1A, the FSI interface is the entire outer surface 130a (indicated by dotted line oval) of the structure 110a. The FSI interface shown in FIG. 1B is the partial outer surface 130b (indicated by dotted line arc) of the structure 110b that overlaps the fluid domain 120b. In FIG. 1C, the FSI interface is the contact location 130c (shown as an oval dot) between the structure 110c and the fluid domain 120c.

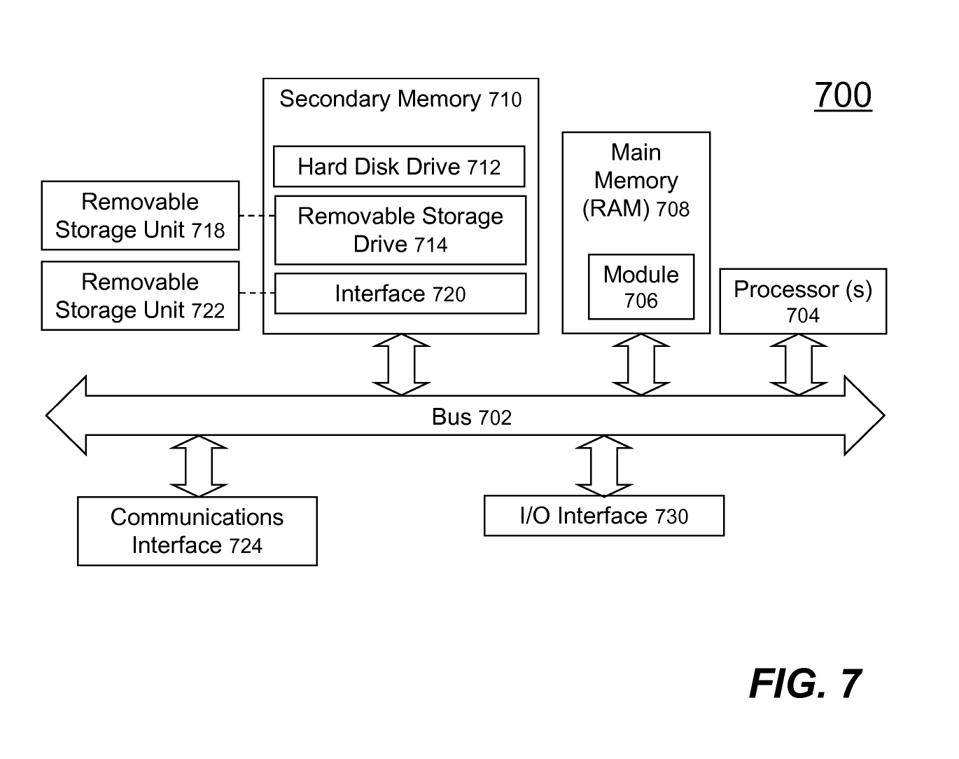

Referring to FIG. 1D, an exemplary finite element analysis (FEA) model 100 representing a structure (e.g., an airplane, a car, etc.) is shown. Structural behaviors under a loading condition can be numerically simulated using finite element analysis with the FEA model in a computer system (e.g., computer 700 of FIG. 7). In one embodiment of the present invention, structural behaviors are numerically simulated with the FEA model in response to fluid loads or forces at fluid structure interaction (FSI) interfaces, which are obtained using the space-time conservation element/solution element (CE/SE) solver with a space-time fluid mesh for the fluid domain adjacent to or surrounding the structure. Other physical mechanisms can also cause the structure to move and/or change shape, for example, thermal expansion, chemical reaction, etc.

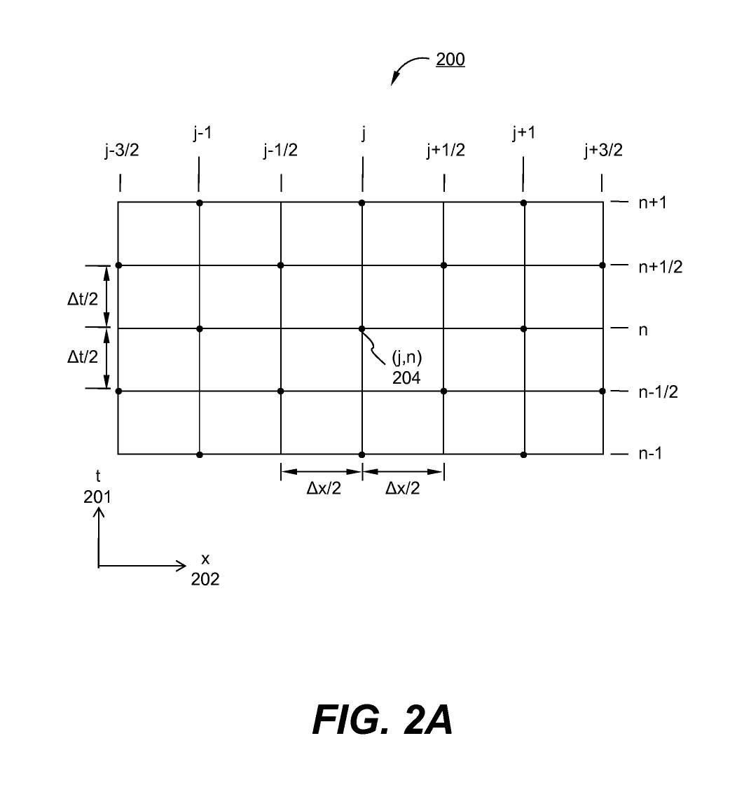

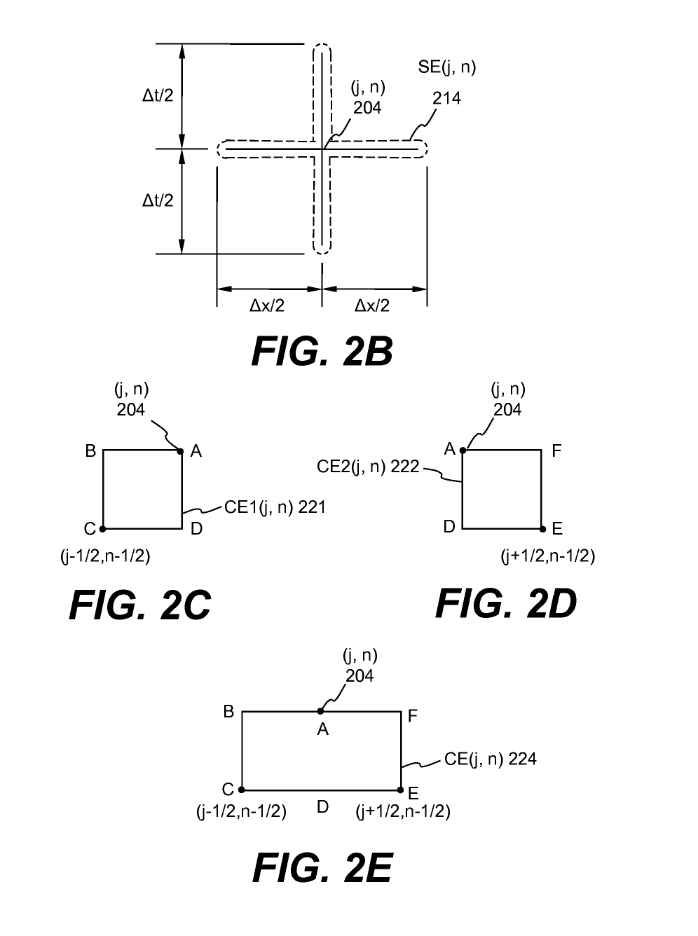

The space-time CE/SE solver is configured to obtain fluid behaviors of a fluid domain represented by a space-time fluid mesh in response to the FSI interaction (e.g., structural deformations). FIGS. 2A-2E are schematic diagrams demonstrating the space-time CE/SE method for one spatial dimension. Shown in FIG. 2A is a mesh 200 configured for the CE/SE solver. The mesh 200 representing a space-time region of fluid domain (the rectangular area covered by the mesh) with two axes: the time axis (t) 201 and the space axis (x) 202. The CE/SE method can be described by considering the following partial differential equation (PDE):

$$\frac{\partial u}{\partial t} + \frac{\partial ( au )}{\partial x} = 0 \qquad ( 1 )$$

where a is a constant and u is a conserved quantity of the fluid domain, for example, density, momentum, energy, etc.

Each mesh points (j,n) 204 (shown as solid dots) is located at the center of a solution element SE(j,n) 214. Indices j and n are for the space axis 202 and the time axis 201, respectively. By definition SE(j,n) 214 is the interior of the space-time region bounded by dash curve shown in FIG. 2B. It includes a horizontal line segment, a vertical line segment, and their immediate neighborhoods.

For any point (x,t) within a SE(j,n), u(x,t), the conserved quantity, and h(x,t), flux vector, are approximated, respectively, by the following formula:

u*(x,t; j,n)≡uⱼ^{u}+(uₓ)ⱼⁿ(x−xⱼ)+(uₜ)ⱼⁿ(t−tⁿ) (2)

and

h*(x,t; j,n)≡(au*(x,t; j,n), u*(x,t; j,n)) (3)

where a is a constant, and uⱼⁿ, (uₓ)ⱼⁿ, (uₜ)ⱼⁿ are constants in SE(j,n); (xⱼ,tⁿ) are coordinates of the mesh point (j,n) 204; and Eq. (3) is the numerical analogue of the definition h=(au,u).

Let u=u*(x,t; j,n) satisfy Eq. (1) within SE(j,n). Then one has (uₜ)ⱼⁿ=−a(uₓ)ⱼⁿ. As a result, Eq. (2) reduces to

u*(x,t; j,n)≡uⱼⁿ+(uₓ)ⱼⁿ[(x−xⱼ)−a(t−tⁿ)] (4)

for each point (x,t) within SE (j,n); i.e., uⱼⁿ and (uₓ)ⱼⁿ are the only independent marching variables associated with mesh point (j,n) 204.

Let the fluid domain be divided into nonoverlapping rectangular regions (see FIG. 2A) referred to as conservation elements (CEs). As respectively depicted in FIGS. 2C and 2D, CE1(j,n) 221 and CE2(j,n) 222 are associated with each interior mesh point (j,n) 204. These two CEs are referred to as basic conservative elements (BCEs). Contrarily, CE(j,n) 224, shown in FIG. 2E referred to as compounded conservation element (CCE) is the union of CE1(j,n) 221 and CE2(j,n) 222.

Among the line segments forming the boundary of CE1(j,n) 221, AB and AD belong to SE(j,n) 214, while CB and CD belong to SE(j−½,n−½). Similarly, the boundary of CE2(j,n) 222 belongs to SE(j,n) 214 and SE(j+½,n−½). As a result, by imposing two conservation conditions at each mesh point (j,n) 204, i.e.,

[symbol]

_{S(CE1(j,n))}h*·ds=0

[symbol]

_{S(CE2(j,n))}h*·ds=0 (5)

and using Eqs. (3) and (4), one obtains (i)

$${u}_{j}^{n} = \frac{1}{2} \{ ( 1 + v ) {u}_{j - \frac{1}{2}}^{n - \frac{1}{2}} + ( 1 - v ) {u}_{j + \frac{1}{2}}^{n - \frac{1}{2}} + ( 1 - {v}^{2} ) [ {( {u}_{x}^{+} )}_{j - \frac{1}{2}}^{n - \frac{1}{2}} - {( {u}_{x}^{+} )}_{j + \frac{1}{2}}^{n - \frac{1}{2}} ] \} \qquad ( 6 )$$

and, assuming 1−v²≠0, (ii)

$${( {u}_{x}^{+} )}_{j}^{n} = \frac{1}{2} \{ {u}_{j + \frac{1}{2}}^{n - \frac{1}{2}} - {u}_{j - \frac{1}{2}}^{n - \frac{1}{2}} - ( 1 - v ) {( {u}_{x}^{+} )}_{j - \frac{1}{2}}^{n - \frac{1}{2}} - ( 1 + v ) {( {u}_{x}^{+} )}_{j + \frac{1}{2}}^{n - \frac{1}{2}} \} \qquad ( 7 )$$

Here v≡aΔt/Δx and (uₓ⁺)ⱼⁿ≡(Δx/4)(uₓ)ⱼⁿ. The solution scheme is formed by Eqs. (6) and (7).

According to Eq. (5), the total flux of h* leaving the boundary of any BCE is zero. Because the surface integration over the interface separating two neighboring BCEs is evaluated using the information from a single SE, obviously the local conservation relation (Eq. (5)) leads to a global flux conservation relation; i.e., the total flux of h* leaving the boundary of any space-time region that is the union of any combination of BCEs will also vanish. In particular, CE(j,n) 224 is the union of CE1(j,n) 221 and CE2(j,n) 222,

[symbol]

_{S(CE(j,n))}h*·ds=0 (8)

must follow Eq. (5). In fact, it can be shown that Eq. (8) is equivalent to Eq. (6).

The above description of the CE/SE method is based on a simple PDE. However, it represents the essence of the general CE/SE development which may involve a system of conservation laws in one, two or three spatial dimensions.

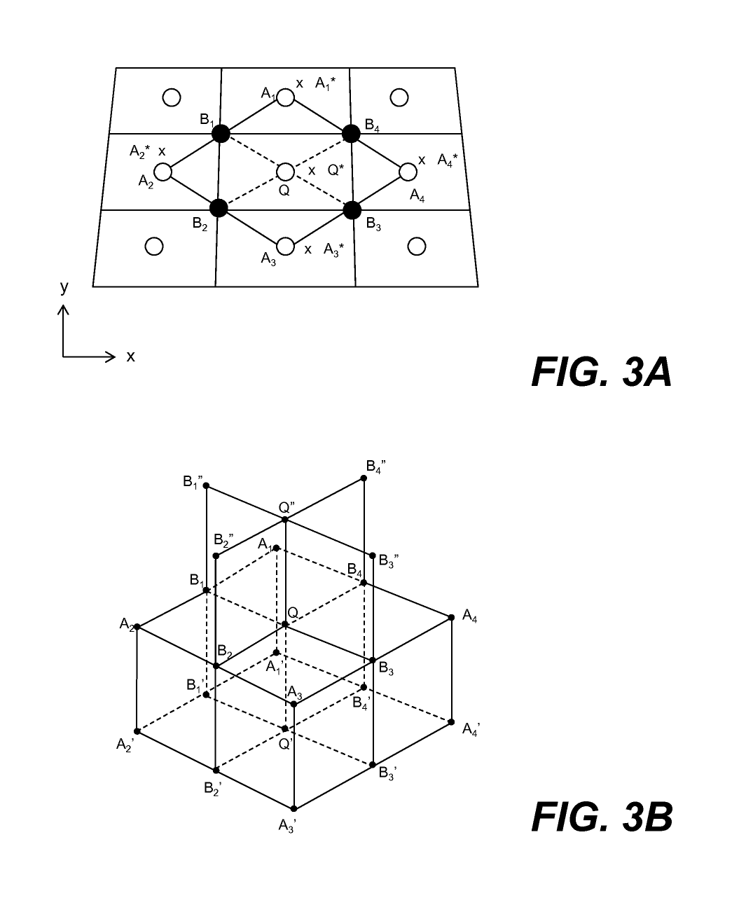

FIGS. 3A-3B are schematic diagrams showing an exemplary space-time fluid mesh for two spatial dimensions. Shown in FIG. 3A, a x-y plane is divided into nonoverlapping convex quadrilaterals and any two neighboring quadrilaterals share a common side. Moreover, (i) vertices and centroids of quadrilaterals are marked by solid dots and circles, respectively; (ii) Q is the centroid of a typical quadrilateral B₁B₂B₃B₄; (iii) A₁, A₂, A₃ and A₄, respectively, are the centroids of the quadrilaterals neighboring to the quadrilateral B₁B₂B₃B₄; and (iv) Q* (marked with a cross “X”) is the centroid of the polygon A₁B₁A₂B₂A₃B₃A₄B₄. Point Q*, generally does not coincide with point Q₅ is referred to as the solution point associated with the centroid Q, And points A₁*, A₂*, A₃*, and A₄* (marked with “x”) are the respective solution points for points A₁, A₂, A₃, and A₄.

Shown in FIG. 3B are an exemplary CE/SE mesh at the n-th time level (t=nΔt, n=0, 1/2, 1, 3/2, . . . ) for given n>0. Points Q, Q′, and Q″, respectively denote the points on the n-th, the (n−1/2)-th, and the (n+1/2)-th time levels with point Q (see FIG. 3A) being the common spatial projection. Other space-time mesh points, such as those depicted in FIG. 3B, and also those not depicted (for illustration clarity), are defined similarly. In particular, points Q*, A_{1*, A}₂*, A₃*, and A₄*, by definition, lie on the n-th time level and, respectively, are the space-time solution points associated with points, Q, A₁, A₂, A₃, and A₄, and points Q′*, A₁′*, A₂′*, A₃′*, and A₄′*, by definition, lie on the (n−1/2)-th time level and, respectively, are the space-time solution points associated with points Q′, A₁′, A₂′, A₃′, and A₄′.

With the above definitions, the solution element of point Q*, denoted by SE(Q*), is defined as the union of five plane segments Q′Q″B₁″B₁′, Q′Q″B₂″B₂′, Q′Q″B₃″B₃′, Q′Q″B₄″B₄′, and A₁B₁A₂B₂A₃B₃A₄B₄ and their immediate neighborhoods. Moreover, the four basic conservation elements (BCEs) of point Q, denoted by CEₖ(Q), k=1, 2, 3, 4, are defined to be the space-time cylinders A₁B₁QB₄A₁′B₁′Q′B₄′, A₂B₂QB₁A₂′B₂′Q′B₁′, A₃B₃QB₂A₃′B₃′Q′B₂′, and A₄B₄QB₃A₄′B₄′Q′B₃′, respectively. In addition, the compounded conservative element of point Q, denoted by CE(Q), is defined to be the space-time cylinder A₁B₁A₂B₂A₃B₃A₄B₄A₁′B₁′A₂′B₂′A₃′B₃′A₄′B₄′, i.e., the union of the above four BCEs

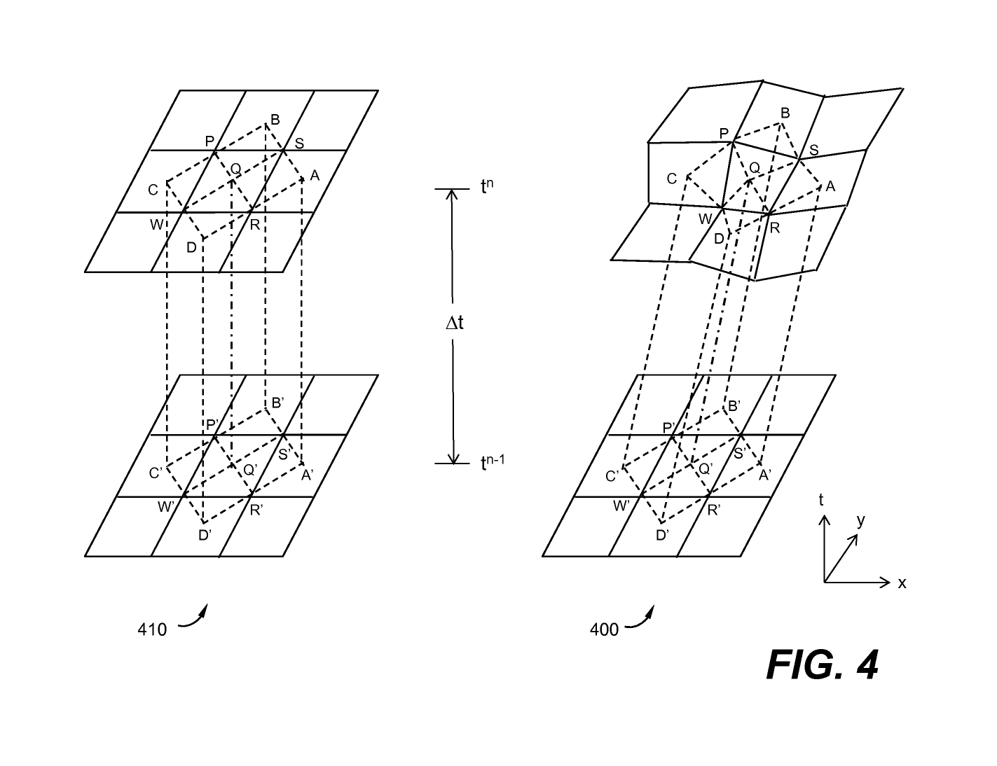

A diagram for comparing a fixed Eulerian mesh 410 and an exemplary moving space-time mesh 400 is shown in FIG. 4. For each solution element SE(Q) within ABCD in the x-y plane, there is a conservation element CE(Q) (i.e., space-time polyhedral ABCDA′B′C′D′) between two time levels tⁿ⁻¹ and tⁿ that are separated by Δt, which is time increment between two solution cycles of a time-marching simulation. CE(Q) contains four BCEs: A′S′Q′R′ASQR, B′P′Q′S′BPQS, C′W′Q′P′CWQP, and D′R′Q′W′DRQW. In one embodiment, a middle-point rule is used in the integral calculations of Eq. (8) for each CE(Q) in the CE/SE method, so the area and unit outward normal vector of all surfaces for each CE(Q) are required, including the top, bottom and lateral surfaces, (e.g., lateral surface A′S′AS).

In the fixed Eulerian mesh 410, all of the geometrical data only need to be calculated one time (during initialization). In the moving mesh 400, the geometrical data are not constant during the time-marching simulation, hence requiring updated data at every solution cycle. In addition, for the moving mesh 400, all the lateral surfaces are considered as space-time surfaces in two-dimensions and space-time polyhedra in three-dimensions. Furthermore, for the fixed Eulerian mesh 410, the normal vector in the time direction is zero. For the moving mesh 400, the normal vector in the time direction may not be zero thereby adding one additional term in evaluating Eq. (8).

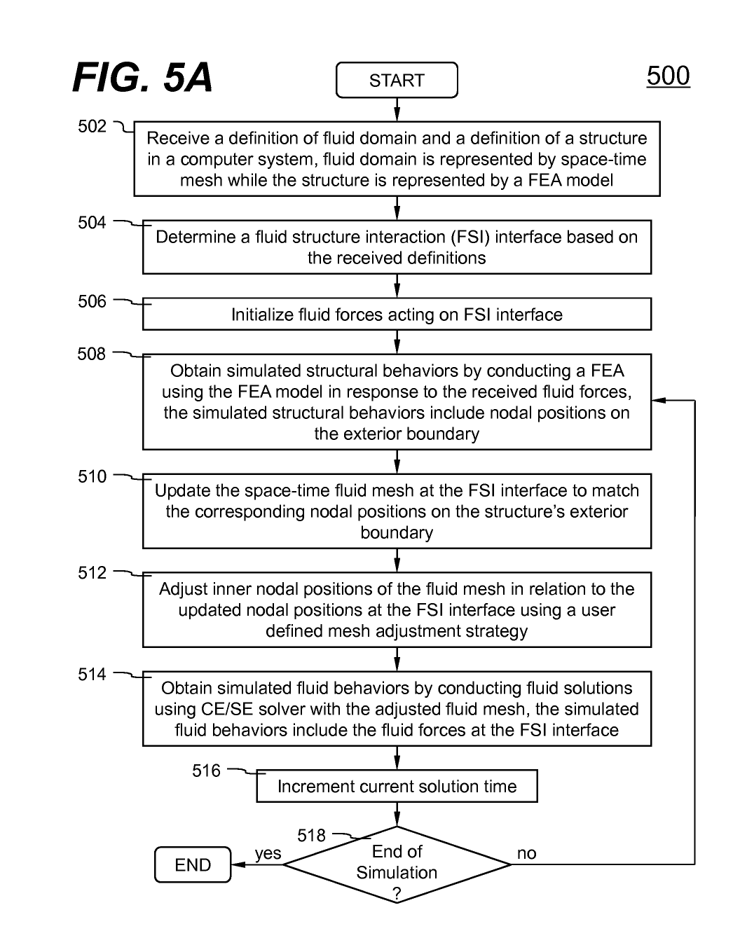

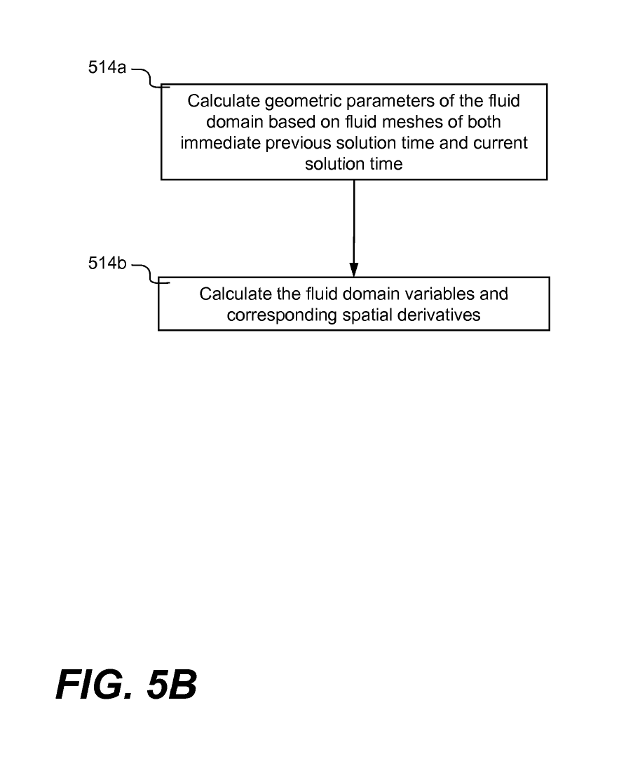

Referring now to FIGS. 5A and 5B, they are collectively shown a flowchart illustrating an exemplary process 500 of numerically simulating fluid structure interaction (FSI) using the space-time conservative element/solution element (CE/SE) solver with a moving fluid mesh coupled to a method of numerically simulating structure mechanics. Process 500 is preferably implemented in software.

At step 502, process 500 starts by receiving a fluid domain definition and a structure definition in a computer system (e.g., computer 700 of FIG. 7) having relevant application modules (e.g., FEA software, space-time CE/SE solver software, etc.) installed thereon. The fluid domain is represented by a space-time fluid mesh configured for solver based on the CE/SE method. The structure is represented by a finite element analysis (FEA) model (e.g., FEA model 100 of FIG. 1D). The fluid domain definition further includes, but is not limited to, fluid density, pressure, velocity, viscosity, etc. The space-time fluid mesh and FEA model can be defined by the user as the fluid domain and structure definitions. For example, volume mesh representing structure or fluid domain can be specified by the user. Or the volume mesh can also be generated by an application module installed on the computer system based on received definitions. For example, the outer surface of the fluid domain or the structure can be defined by the user and received in the computer system. A corresponding CE/SE fluid mesh or FEA model (volume model) is then created based on the received surface definition.

A fluid structure interaction (FSI) interface between the fluid domain and the structure is determined using the received definitions at step 504. According to one embodiment of the present invention, no common or aligned node or edge is needed between the space-time fluid mesh and the FEA model. The only requirement is that the fluid domain and the structure having FSI interfaces lie approximately in the same surface (e.g., FSI interfaces 130a-130c shown in FIGS. 1A-1C). In other words, a FSI interface coincides with part or all of the structure's exterior boundary. Next, at step 506, after initializing all state variables of the solvers, parameters of a time-marching simulation of FSI are initialized, for example, initial fluid forces acting on the FSI interface for the FEA model.

At step 508, simulated structural behaviors are obtained by performing a FEA using the FEA model in response to the received fluid forces at the FSI interface. The simulated structural behaviors include, but are not limited to, nodal positions of the exterior boundary of the structure (e.g., at the FSI interface). FEA can be explicit or implicit finite element analysis. One exemplary FEA software package is the LS-DYNA® product offered by Livermore Software Technology Corporation.

At step 510, process 500 the space-time fluid mesh is updated accordingly using the newly-obtained nodal positions (i.e., the structural behaviors) at the FSI interface from the FEA. Next, at step 512, inner mesh nodes of the fluid mesh are adjusted in accordance with the updated nodal position at the FSI interface using a user-selected mesh adjustment strategy including, but not limited to, ball-vertex method, inverse distance weighting method, radial basis function method, etc.

After the new fluid mesh has been updated, at step 514, simulated fluid behaviors are obtained by conducting a fluid solution using the CE/SE solver in the newly-adjusted fluid mesh. The simulated fluid behaviors include fluid forces acting on the FSI interface. In particular, shown in FIG. 5B, process 500 performs calculations of geometric parameters of the fluid domain based on space-time fluid meshes at both immediate previous solution time and the current solution time at step 514a. And, at step 514b, the fluid domain variables (e.g., fluid density, pressure, velocity, viscosity, etc.) and corresponding spatial derivatives are calculated. The immediate previous solution time and the current solution time is separated by a time increment Δt.

Next, the current solution time for the time-marching simulation is incremented to next solution cycle (e.g., increment the current solution time by adding a time increment Δt) at step 516. Process 500 moves to decision 518 to determine whether the numerical simulation of FSI is ended. If not, process 500 moves back to repeat steps 508-516 for another solution cycle for obtaining simulated FSI. Otherwise, process 500 ends. The ending condition includes, but is not limited to, a predefined total simulation time is reached.

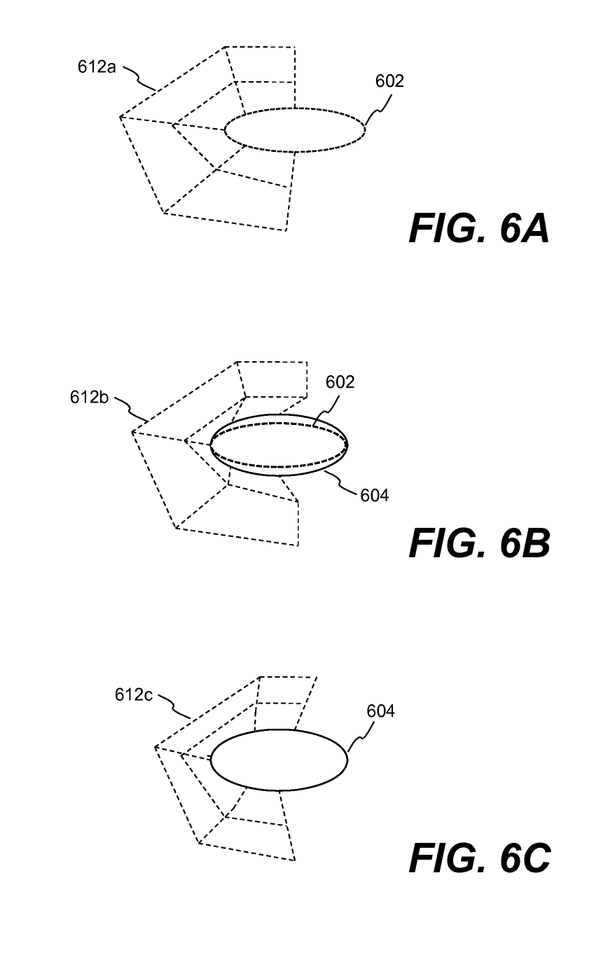

FIGS. 6A-6C are a series of schematic diagrams showing an exemplary space-time fluid mesh adjustment in response to simulated structural behaviors (e.g., structure deformations and new nodal positions), according to an embodiment of the present invention. In FIG. 6A, a FEA model representing a structure 602 (shown as a dotted line ellipse) is adjacent to a space-time fluid mesh 612a (shown as a two-dimensional mesh for illustration simplicity). The FEA model and the space-time fluid mesh 612a overlap each other.

In FIG. 6B, deformed structure 604 (solid line ellipse) is the simulation result of the structure 602 in response to received fluid forces at FSI interface. The space-time fluid mesh 612b is updated to reflect new nodal positions/velocities obtained from the simulated structural behaviors.

Finally, in FIG. 6C, interior nodes of the space-time fluid mesh 612c are adjusted according to the new nodal positions at the FSI interface using a user-selected mesh adjustment strategy.

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the finite element analysis and/or the space-time CE/SE solver is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas space-time fluid meshes have been shown as two-dimensional (for one spatial dimension) and three-dimensional (for two spatial dimensions), the space-time fluid mesh is four-dimensional (for three spatial dimensions) and is not easily illustrated in a figure. In summary, the scope of the invention should not be restricted to the specific exemplary embodiments disclosed herein, and all modifications that are readily suggested to those of ordinary skill in the art should be included within the spirit and purview of this application and scope of the appended claims.

We claim:

1. A method of numerically simulating fluid structure interaction (FSI) using the space-time conservative element/solution element (CE/SE) solver with a moving fluid mesh, said method comprising:
(a) receiving a fluid domain definition and a structure definition in a computer system having finite element analysis (FEA) and CE/SE solver application modules installed thereon, the fluid domain definition comprising a space-time fluid mesh configured for the CE/SE solver while the structure definition comprising a FEA model;
(b) determining a FSI interface using the space-time fluid mesh and the FEA model;
(c) initializing fluid forces acting on the FSI interface for the FEA model;
(d) obtaining numerically simulated structural behaviors by conducting a FEA using the FEA model in response to the received fluid forces, the numerically simulated structural behaviors including nodal positions of the FEA model on the structure's exterior boundary;
(e) updating the fluid mesh at the FSI interface to match the nodal positions of the structure's exterior boundary;
(f) adjusting inner nodal positions of the fluid mesh according to the nodal positions at the FSI interface using a user-selected mesh adjustment strategy;
(g) obtaining numerically simulated fluid behaviors by conducting fluid solution using the CE/SE solver with the adjusted fluid mesh, the simulated fluid behaviors including the fluid forces at the FSI interface;
(h) incrementing current solution time; and
(i) repeating (d) to (h) until an ending condition is met.

2. The method of claim 1, wherein the space-time fluid mesh is four dimensional when the fluid domain has three spatial dimensions.

3. The method of claim 1, wherein the FSI interface coincides with part or all of the structure's exterior boundary.

4. The method of claim 1, wherein the space-time fluid mesh and the FEA model do not have to share common nodes or edges.

5. The method of claim 1, wherein said conducting the fluid solutions further comprises calculating geometric parameters of the fluid domain based on the fluid mesh of the immediately previous solution cycle and the adjusted fluid mesh of the current solution cycle.

6. The method of claim 5, further comprises calculating fluid domain variables and corresponding spatial derivatives.

7. The method of claim 6, wherein the fluid domain variables include fluid density, pressure, velocity, viscosity and the likes.

8. The method of claim 1, wherein the space-time fluid mesh is three dimensional when the fluid domain has two spatial dimensions.

9. A system for numerically simulating fluid structure interaction (FSI) using the space-time conservative element/solution element (CE/SE) solver with a moving fluid mesh, said system comprising:
a main memory for storing computer readable code for finite element analysis (FEA) and CE/SE application modules;
at least one processor coupled to the main memory, said at least one processor executing the computer readable code in the main memory to cause the application modules to perform operations by a method of:
(a) receiving a fluid domain definition and a structure definition, the fluid domain definition comprising a space-time fluid mesh configured for the CE/SE solver while the structure definition comprising a FEA model;
(b) determining a FSI interface using the space-time fluid mesh and the FEA model;
(c) initializing fluid forces acting on the FSI interface for the FEA model;
(d) obtaining numerically simulated structural behaviors by conducting a FEA using the FEA model in response to the received fluid forces, the numerically simulated structural behaviors including nodal positions of the FEA model on the structure's exterior boundary;
(e) updating the fluid mesh at the FSI interface to match the nodal positions of the structure's exterior boundary;
(f) adjusting inner nodal positions of the fluid mesh according to the nodal positions at the FSI interface using a user-selected mesh adjustment strategy;
(g) obtaining numerically simulated fluid behaviors by conducting fluid solution using the CE/SE solver with the adjusted fluid mesh, the simulated fluid behaviors including the fluid forces at the FSI interface;
(h) incrementing the current solution time; and
(i) repeating (d) to (h) until an ending condition is met.

10. The system of claim 9, wherein the space-time fluid mesh is four dimensional when the fluid domain has three spatial dimensions.

11. The system of claim 9, wherein the space-time fluid mesh is three dimensional when the fluid domain has two spatial dimensions.

12. The system of claim 9, wherein said conducting the fluid solutions further comprises calculating geometric parameters of the fluid domain based on the fluid mesh of immediately previous solution cycle and the adjusted fluid mesh of the current solution cycle.

13. The system of claim 12, further comprises calculating fluid domain variables and corresponding spatial derivatives.

14. The system of claim 13, wherein the fluid domain variables include fluid density, pressure, velocity, viscosity and the likes.

15. A non-transitory computer readable storage medium containing instructions, when executed in a computer system, for numerically simulating fluid structure interaction (FSI) using the space-time conservative element/solution element (CE/SE) solver with a moving fluid mesh by a method comprising:
(a) receiving a fluid domain definition and a structure definition in a computer system having FEA and CE/SE solver application modules installed thereon, the fluid domain definition comprising a space-time fluid mesh configured for the CE/SE solver while the structure definition comprising a FEA model;
(b) determining a FSI interface using the space-time fluid mesh and the FEA model;
(c) initializing fluid forces acting on the FSI interface for the FEA model;
(d) obtaining numerically simulated structural behaviors by conducting a FEA using the FEA model in response to the received fluid forces, the numerically simulated structural behaviors including nodal positions of the FEA model on the structure's exterior boundary;
(e) updating the fluid mesh at the FSI interface to match the nodal positions of the structure's exterior boundary;
(f) adjusting inner nodal positions of the fluid mesh according to the nodal positions at the FSI interface using a user-selected mesh adjustment strategy;
(g) obtaining numerically simulated fluid behaviors by conducting fluid solution using the CE/SE solver with the adjusted fluid mesh, the simulated fluid behaviors including the fluid forces at the FSI interface;
(h) incrementing the current solution time; and
(i) repeating (d) to (h) until an ending condition has met.

16. The non-transitory computer readable storage medium of claim 15, wherein the space-time fluid mesh is four dimensional when the fluid domain has three spatial dimensions.

17. The non-transitory computer readable storage medium of claim 15, wherein the space-time fluid mesh is three dimensional when the fluid domain has two spatial dimensions.

18. The non-transitory computer readable storage medium of claim 15, wherein said conducting the fluid solutions further comprises calculating geometric parameters of the fluid domain based on the fluid mesh of immediately previous solution cycle and the adjusted fluid mesh of the current solution cycle.

19. The non-transitory computer readable storage medium of claim 18, further comprises calculating fluid domain variables and corresponding spatial derivatives.

20. The non-transitory computer readable storage medium of claim 19, wherein the fluid domain variables include fluid density, pressure, velocity, viscosity and the likes.
